(19) United States
(12) Patent Application Publication
(10) Pub. No.: US 2021/0209548 A1
(43) Pub. Date: Jul. 8, 2021

(54) VEHICLE TRUNK DELIVERY SYSTEM AND METHOD

(71) Applicants: HOWARD B. KATZ, BOCA RATON, FL (US); ROMAN GOLD, TORONTO (CA)

(72) Inventors: HOWARD B. KATZ, BOCA RATON, FL (US); ROMAN GOLD, TORONTO (CA)

(21) Appl. No.: 17/034,484

(22) Filed: Sep. 28, 2020

Related U.S. Application Data
(60) Provisional application No. 62/956,806, filed on Jan. 3, 2020.
(60) Provisional application No. 63/016,854, filed on Apr. 28, 2020.

(51) Int. Cl. G06Q 10/08; B60R 25/24; B60R 25/20

(52) U.S. Cl. CPC G06Q 10/0832; B60R 25/2018; B60R 25/246

(57) ABSTRACT

A system and method for securely delivering a package to a trunk of a vehicle. An administrator generates an electronic key that is assigned to a communication device and the communication device is coupled to the OBD system of vehicle. A courier service or individual courier uses the electronic key to transmit a trunk-open command to the communication device coupled to the OBD system of the parked customer vehicle. Alternatively, a courier may leave the package in the trunk of a parked courier vehicle and the customer may use the electronic key to transmit a trunk-open command to the communication device coupled to the OBD system of the parked courier vehicle.

### CROSS-REFERENCE TO RELATED APPLICATIONS

This non-provisional application claims priority to U.S. Provisional Application No. 62/956,806, titled TRUNK DELIVERY PACKAGE, which was filed on Jan. 3, 2020 and also claims priority to U.S. Provisional Application No. 63/016,854, titled ON-DEMAND TRUNK DELIVERY NETWORK, which was filed on Apr. 28, 2020, both of which are incorporated herein in full by reference.

### FIELD OF THE INVENTION

The present invention relates generally to the field of package delivery services. More specifically, the present invention is a system and method for secure delivery of packages to the unattended vehicle trunk of the recipient.

### BACKGROUND OF THE INVENTION

Most people rely on parcel/package delivery as a means for sending and receiving personal items or for sending and receiving goods. Sometimes, items delivered by the United States Postal Service (USPS) are too large to fit into a standard sized mailbox, so they are left by the front door of a business or residence. Companies like FEDEX delivery service or UNITED PARCEL SERVICE (UPS) delivery service also leave delivered packages by the front doors of businesses and residences. Unfortunately, because these packages are simply left out in the open, they are very easy to steal.

As a preventative measure, some homeowners and business owners have installed security cameras that videotape the area in front of their doorsteps to discourage the theft of any delivered packages. Security cameras do not offer much help in preventing the packages from being stolen, however, because a thief merely needs to wear nondescript clothing and a mask to conceal their identity. Furthermore, any videotape of the package theft would be after-the-fact and does little to prevent the actual theft from occurring in the first place. A need therefore exists for a system and method of delivering a package to a secure location, such as the unattended vehicle trunk of the package recipient.

### SUMMARY

In accordance with one or more embodiments of the present invention, a system for securely delivering a package to a trunk of a vehicle is disclosed. The system comprises: a network configured for communication between an administrator, a plurality of couriers, a plurality of package senders, and a plurality of package recipients; and at least one administrator server with a database containing information for the plurality of package senders and the plurality of package recipients, wherein the at least one administrator server has a processor configured to access the database and to execute a set of program instructions causing the processor to: generate an electronic key to be assigned to a specific vehicle associated with a courier or a package recipient; receive a request for a trunk delivery from a package sender, the delivery request identifying the package recipient; assign the trunk delivery to the courier; identify the specific vehicle associated with the courier or the package recipient; transmit the electronic key that is assigned to the specific vehicle to at least one of the package sender, the courier, and the package recipient; update status of the trunk delivery; and communicate with at least one of the package sender, the courier, and the package recipient relating to status of the trunk delivery.

In accordance with one or more embodiments of the present invention, a method for securely delivering a package to a trunk of a vehicle is disclosed. The method comprises the steps of generating an electronic key to be assigned to a specific vehicle associated with a courier or a package recipient; receiving a request for a trunk delivery from a package sender, the delivery request identifying the package recipient; assigning the trunk delivery to the courier; identifying the specific vehicle associated with the courier or the package recipient; transmitting the electronic key that is assigned to the specific vehicle to at least one of the package sender, the courier, and the package recipient; updating status of the trunk delivery; and communicating with at least one of the package sender, the courier, and the package recipient relating to the status of the trunk delivery.

In accordance with one or more embodiments of the present invention, a method for securely delivering a package to a trunk of a vehicle is disclosed. The method comprises the steps of: generating an electronic key to be assigned to a communication device; associating the communication device with a vehicle identification number (VIN) of a specific vehicle associated with a courier or a package recipient; issuing the communication device to the courier or the package recipient so that it may be coupled to an on-board device of the specific vehicle associated with the courier or the package recipient; receiving a request for a trunk delivery from a package sender, the delivery request identifying the package recipient; identifying the specific vehicle associated with the courier or the package recipient; identifying the electronic key assigned to the communication device that is associated with the VIN of the specific vehicle associated with the courier or the package recipient; and transmitting the electronic key assigned to the communication device that is associated with the VIN of the specific vehicle associated with the courier or the package recipient to at least one of the package sender, the courier, and the package recipient; wherein the communication device, when coupled to the on-board device of the specific vehicle associated with the courier or the package recipient, will only execute a trunk-open command if the electronic key is transmitted from a courier electronic device or from a package recipient electronic device and is received by the communication device coupled to the on-board device of the specific vehicle associated with the courier or the package recipient.

### BRIEF DESCRIPTION OF THE DRAWINGS

The present application is further detailed with respect to the following drawings. These figures are not intended to limit the scope of the present application, but rather, illustrate certain attributes thereof.

FIG. 1 is an exemplary vehicle trunk delivery system according to one or more aspects of the present invention;

FIG. 2 is an exemplary diagram showing communications occurring between and among hardware components of the system of FIG. 1;

FIG. 3 is an exemplary flowchart showing the steps performed by an individual courier in accordance with one or more aspects of the system of FIG. 1;

FIG. 4 is an exemplary flowchart showing the steps performed by a courier service in accordance with one or more aspects of the system of FIG. 1;

FIG. 5 is an exemplary flowchart showing the steps performed by a retailer in accordance with one or more aspects of the system of FIG. 1;

FIG. 6 is an exemplary diagram showing a vehicle trunk delivery method according to one or more aspects of the system of FIG. 1; and

FIG. 7 is an exemplary diagram showing an on-demand same day delivery method according to one or more aspects of the system of FIG. 1.

### DETAILED DESCRIPTION OF THE INVENTION

The description set forth below in connection with the appended drawings is intended as a description of presently preferred embodiments of the disclosure and is not intended to represent the only forms in which the present disclosure may be constructed and/or utilized. The description sets forth the functions and the sequence of steps for constructing and operating the disclosure in connection with the illustrated embodiments. It is to be understood, however, that the same or equivalent functions and sequences may be accomplished by different embodiments that are also intended to be encompassed within the spirit and scope of this disclosure.

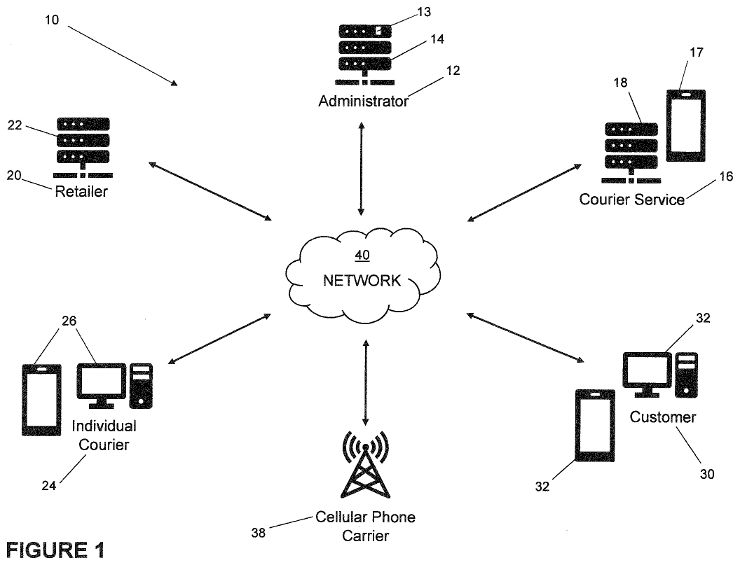

FIGS. 1-7 together disclose a vehicle trunk delivery system and method of the present invention. Referring to FIG. 1, an exemplary vehicle trunk delivery system 10 is shown. The system 10 provides a method that allows for the secure delivery of a parcel/package 42 to the trunk 35 of an unattended vehicle 34 of the customer/recipient 30. Although parcel/package 42 delivery is specifically mentioned, it should be clearly understood that substantial benefit may be derived from use of the system 10 for the delivery of mail, letters, any other type of item typically sent through the USPS or other delivery service, depending on the size of the package.

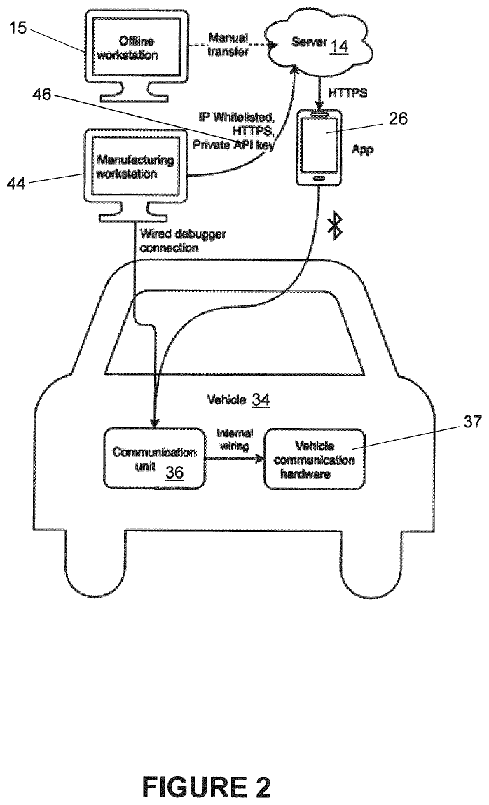

The system 10 may comprise a system administrator 12, one or more delivery/courier service(s) 16, one or more individual courier(s) 24, one or more retailer(s) 20, one or more electronic device(s) 32 operated by one or more customer(s) 30, and cellular phone carriers 38 all connected via a network 40. It should be understood that the term “courier” may be used generically herein to refer to either a courier service 16 or individual courier 24. The network 40 may be connected by wired or wireless means which may include, but not limited to, cellular, satellite, local area network (LAN), wide area network (WAN), Virtual Private Networks (VPN), or global network (e.g. Internet). The network 40 may also include short range BLUETOOTH wireless technology when a courier service 16, an individual courier 24, or a customer 30 is using their respective electronic device 17, 26, 32 to communicate locally with a communication unit/device 36 (shown FIG. 2) coupled to the on-board device (OBD) system 37 of the customer's 30 vehicle 34 (shown in FIG. 2). Although the OBD system 37 detailed herein is described as “OBD,” it should be clearly understood that the OBD system 37 may include any past, current, or future versions or iterations of a vehicle on-board device (e.g. OBD, OBD, etc.).

In the system 10, the administrator 12, the courier service 16, and the retailer 20 may communicate with each other over the network 40 via their respective server(s) 14, 18, 22 wherein each server 14, 18, 22 may have a processor that 13 stores/executes its own related computer program software. Although the administrator 12, the courier service 16, and the retailer 20, are depicted as having one server 14, 18, 22 each, it should be understood that substantial benefit may also be derived from the administrator 12, the courier service 16, and/or the retailer 20 having more than one server 14, 18, 22 each. A driver for the courier service 16 may communicate directly with the administrator 12 on his/her electronic device 17. Where the driver for the courier service 16 has an electronic device 17 that is smartphone or tablet, the driver for the courier service 16 may communicate with the administrator 12 via his/her cellular phone carrier 38 or directly through the network 40 via the Internet. Alternatively, the driver for the courier service 16 may communicate with the courier service 16 through his/her electronic device 17 and the courier service 16 may then communicate directly with the administrator 12 through the network 40.

An individual courier 24 may communicate with the administrator 12 or the retailer 20 on his/her electronic device 26. Where the individual courier's 24 electronic device 26 is a smartphone or tablet, the individual courier 24 may communicate with the administrator 12 or the retailer 20 via his/her cellular phone carrier 38 or directly through the network 40 via the Internet. Where the individual courier's 24 electronic device 26 is a desktop computer, the individual courier 24 may communicate with the administrator 12 or the retailer 20 through the network 40 via the Internet. The customer 30 may communicate with the administrator 12, courier service 16, retailer 20, or individual courier 24 on his/her electronic device 32. Where the customer's 30 electronic device 32 is a smartphone, smart watch or tablet, the customer 30 may communicate with the administrator 12, courier service 16, retailer 20, or individual courier 24 via his/her cellular phone carrier 38 or directly through the network 40 via the Internet. Where the customer's 30 electronic device 32 is a desktop computer, the customer 30 may communicate with the administrator 12, courier service 16, retailer 20, or individual courier 24 through the network 40 via the Internet.

The administrator's 12 server 14 may have a processor 13 and memory or database for storing information relating to the courier services 16, the retailers 20, the individual couriers 24, and the customers 30. For example, regarding information about a customer 30, the administrator's 12 database may store information such as the customer's 30 name, authentication credentials (e.g. identification and password), contact information (e.g. phone number, address, e-mail, etc.), Vehicle Identification Number (VIN), description of the customer's 30 vehicle 34 (e.g. make, model, color, and size of the trunk 35 of the customer's 30 vehicle 34), as well as the customer's 30 credit card/debit card/bank account information if required. Regarding information about an individual courier 24, the administrator's 12 database may store information such as the individual courier's 24 name, authentication credentials (e.g. identification and password), contact information (e.g. phone number, address, e-mail, etc.), Vehicle Identification Number (VIN), description of the individual courier's 24 vehicle 28 (e.g. make, model, color, and trunk size), as well as the individual courier's 24 insurance information, driving record and any criminal record.

The processor 13 may be implemented in hardware, software, or a combination thereof. The processor 13 may store a computer program or other programming instructions associated with the database to control the operation of the system 10. The data and structures and code within the software in which the present invention may be implemented, may typically be stored on a non-transitory computer-readable storage. The storage may be any device or medium that may store code and/or data for use by a computer system (and may include cloud storage). The non-transitory computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed. The processor 13 may comprise various computing elements, such as integrated circuits, microcontrollers, microprocessors, programmable logic devices, etc. alone or in combination to perform the operations described herein.

FIG. 2 is a diagram showing examples of communications that may occur between and among some hardware components of the vehicle trunk delivery system 10. The administrator's 12 server 14 is primarily used to manage system users (customers 30, courier services 16, retailers 20, and individual couriers 24), electronic devices, and user permissions on those devices. An application (referred to herein as “app” or “APP”) may be downloaded, stored, and implemented by system users on their respective devices to perform certain actions. The system 10 also uses a Public Key Infrastructure (PKI) security model, with message-based communication between the system components.

Through VIN detection, a customer's 30 vehicle 34 is assigned to the administrator server 14 which authorizes the upload and storage of trunk-open commands into the communication device 36 that is connected to the OBD system 37 of the customer's 30 vehicle 34. The communication device 36 in vehicle 34 may therefore have its own processor and memory or database for storing information relating to the receipt, storage, and execution of trunk-open commands. Alternatively, the communication device 36 may simply relay the trunk-open commands directly to the OBD system 37 of the customer's 30 vehicle 34. Alternatively, the application saved in the customer's 30 electronic device 32 is then used by the customer 30 to share the trunk-open command and grant access to third parties such as individual couriers 24 or courier services 16. Alternatively, a the OBD system 37 can receive a one-time use knock sequence that will execute a safe fail command that was requested from the administrator 12.

An offline workstation 15 may be used to sign public keys (also referred to herein as “electronic keys 46”) that are used by the server 14 and other devices to verify the integrity of messages. A unique C. The offline workstation 15 may be isolated from local and wide-area networks to prevent private signing keys from being compromised via over-the-network attacks. In one or more embodiments, the private signing keys may rarely be used—only in the case where a new server 14 is commissioned—and form the root of trust of the public key encryption processed used in the system 10.

The remote server 14 provides a secure web-based service. The application runs on the customer's 30 personal mobile or desktop electronic device 32. The application allows the customer's 30 electronic device 32 to communicate with the remote server 14 and the communication device 36 that is connected to the OBD system 37 of the customer's 30 vehicle 34. The application allows the communication with the remote server 14 over the Internet using hypertext transfer protocol secure (HTTPS) with the strongest available transport layer security (TLS) version and cipher suite. BLUETOOTH wireless communication with the communication device 36 is considered insecure and may be susceptible to sniffing, tampering, and jamming. All data sent over this communication path is therefore signed and encrypted to prevent spoofing, tampering, or information disclosure.

The communication device 36 and vehicle communication hardware (i.e. the OBD system 37 of the customer's 30 vehicle 34) are installed in the vehicle 34 and are considered inaccessible to people outside of the vehicle 34 when locked. The communication device 36 validates communications from the administrator 12 and the server 14 and controls features of the customer vehicle 34 through the customer vehicle's 34 OBD system 37. The communication device 36 may have its own power supply or it may use the power supply of the customer vehicle 34.

The system 10 may make use of random number generators for the electronic key 46 signatures. The server 14 and application platforms provide true random number generators for electronic key 46 signature and challenge generation via standard system APIs. The firmware may use mbed TLS CTR-DRBG random generators standardized by National Institute of Standards and Technology (NIST) (e.g. NIST SP 800-90A Rev. 1) with a hardware RNG as an entropy source. The server 14, applications, and firmware may protect private keys in secure storage where available, and prevent access by untrusted third parties. Physical security may be provided for the offline workstation's 15 private key and the workstation 15 itself. In a preferred embodiment, the private workstation 15 is only used for generating new server 14 keys and should not be connected to the Internet.

The manufacturing workstations 44 may only have API access to create new communication devices 36 and the manufacturing workstation 44 API key is periodically refreshed. All messages may be encrypted in transit using AES-256-GCM encryption, OPENSSL software may be used on the server 14, standard iOS system APIs may be used in the application, and mbed TLS may be used as the firmware. Additional authentication data may be used as much as possible. A 16-byte media access control (MAC) address may be used in all messages and a 12-byte initialization vector (IV) may be used in generating all message. Shared secrets may be derived from key pairs with ECDH key protocol using the secp256r1 curve and hashed with SHA256 hash functions. Messages may include a counter (server messages) or challenges (user messages) to ensure that every generated message is unique. The challenges in the application and firmware should be refreshed after every message is processed. Messages may include a 4-20-byte random length and random data blob to ensure that messages have varying length and content. Messages may be processed on the communication device 36 at a time to avoid conflicts. OBD system 37 configurations may be signed with a separate key to ensure that, in the event of server 14 compromise, malicious configurations could not be sent to communication devices 36. Firmware updates may be signed with a separate key. At manufacture, the debug interface of the system-o-chip (SoC) is locked to prevent reading or writing of FLASH software and random-access memory (RAM).

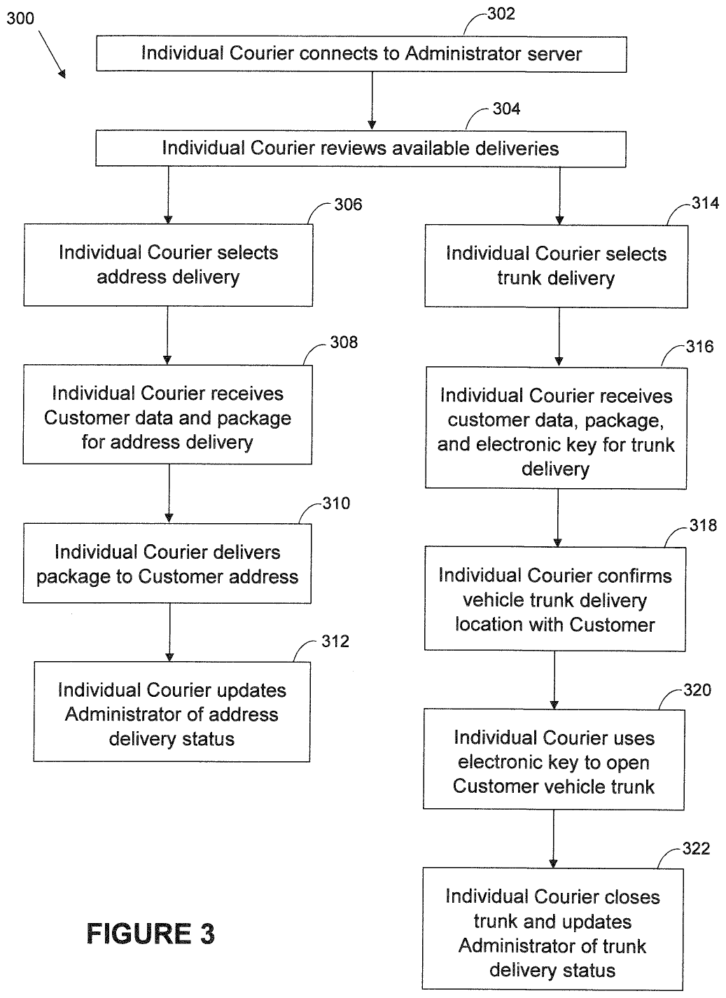

FIG. 3 is a flow diagram showing an exemplary method 300 involving an individual courier 24. As a preliminary matter, a person may apply to the administrator 12 to be accepted as an individual courier 24. To apply, the person may provide the administrator 12 with personal information such as, but not limited to, individual courier's 24 name, authentication credentials (e.g. identification and password), contact information (e.g. phone number, address, e-mail, etc.), Vehicle Identification Number (VIN), description of individual courier's 24 vehicle 28 (e.g. make, model, color), as well as the individual courier's 24 insurance information, driving record and any criminal record. If approved, the individual courier 24 will receive API access for user and permission exchange. The individual courier 24 may be assigned a unique identification name and/or number so that the individual courier 24 may be easily identified within the system 10. The distance that the individual courier 24 may drive for any package delivery may be limited by the administrator 14 or upon request by the individual courier 24. In one or more embodiments of the present invention, the individual courier 24 may also be associated with other services such as UBER ride share, LYFT ride share and may make package deliveries while also offering services for the ride share programs. Where the individual courier 24 is associated with other ride share programs, the ride share programs may have servers that are also connected to the network 40. Alternatively, in accordance with one or more embodiments of the present invention, the individual courier 24 may be associated only with the administrator 14 and may not be working with any other ride share programs.

Once a person has been approved by the administrator 12, the individual courier 24 may decide which deliveries he/she wishes to execute. In FIG. 3, at step 302, an individual courier 24 may connect to the administrator's 12 server 14 directly through the Internet or through an application stored on the individual courier's 24 electronic device 26. At step 304, once the individual courier 24 is connected to the server 14, the individual courier 24 may view all of the available package deliveries. The list of package deliveries may be filtered or sorted by distance, by time, and/or by type of delivery (i.e. address delivery or vehicle trunk delivery). At step 306, the individual courier 24 may select an address delivery. Upon selecting an address delivery, the individual courier 24 will receive customer data relating to the address delivery (step 308). The customer data for the address delivery may include the customer's 30 name, customer's 30 delivery address, sender's address, package description (e.g. size, weight, contents, etc.), package pick-up time and location, package delivery time, as well as any other relevant information. The package sender may be a retailer 20 or may be any individual or other entity. The individual courier 24 will then pick up the package 42 from the sender. At step 310, the individual courier 24 will deliver the package 42 to the delivery address of the customer 30. After making the delivery, the individual courier 24 will inform the administrator 12 that the delivery has been completed so that the administrator 12 may update the status of the delivery (step 312) and may inform the customer 30 that the package 42 has been delivered.

Still referring to FIG. 3, at step 314, the individual courier 24 may select a vehicle trunk delivery. Upon selecting a vehicle trunk delivery, the individual courier 24 will receive customer data relating to the vehicle trunk delivery (step 316). The customer data for the vehicle trunk delivery may include the customer's 30 name, location of customer's 30 vehicle (e.g. parking lot address, cross streets, etc.), description of customer's 30 vehicle 34 (e.g. vehicle make, model, color, VIN number, license plate, etc.), sender's address, package description (e.g. size, weight, contents, etc.), package pick-up time and location, package delivery time, as well as any other relevant information. The individual courier 24 will also receive from the administrator 12 the electronic key 46 associated with the communication device 36 installed in the customer's 30 vehicle 34. The sender may be a retailer 20 or may be any individual or other entity. The individual courier 24 will then pick up the package 42 from the sender. At this time, the individual courier 24 may send the customer 30 a Short Message Service (SMS) text message to confirm the location of customer's 30 vehicle 34 and the customer 30 uses his/her electronic device 32 to confirm the delivery location of the vehicle 34 or advise an alternative delivery location (step 318). At the agreed upon delivery location, the individual courier 24 will drive to the location of the customer's 30 vehicle 34. At step 320, when the individual courier 24 has located the customer's 30 vehicle 34, the communication device 36 connected to the OBD system 37 of the customer's 30 vehicle 34 will receive and execute the trunk-open command transmitted by the individual courier's 24 electronic device 26 via BLUETOOTH wireless connection (the electronic key 46 allows the communication device 36 to receive the trunk-open command transmitted by the individual courier's 24 electronic device 26). After placing the package 42 into the trunk 35, the individual courier 24 may take a photograph of the package 42 in the trunk 35 and close the trunk 35 and will inform the administrator 12 that the delivery has been completed so that the administrator 12 may update the status of the delivery (step 322) and may also inform the customer 30 that the package 42 has been delivered.

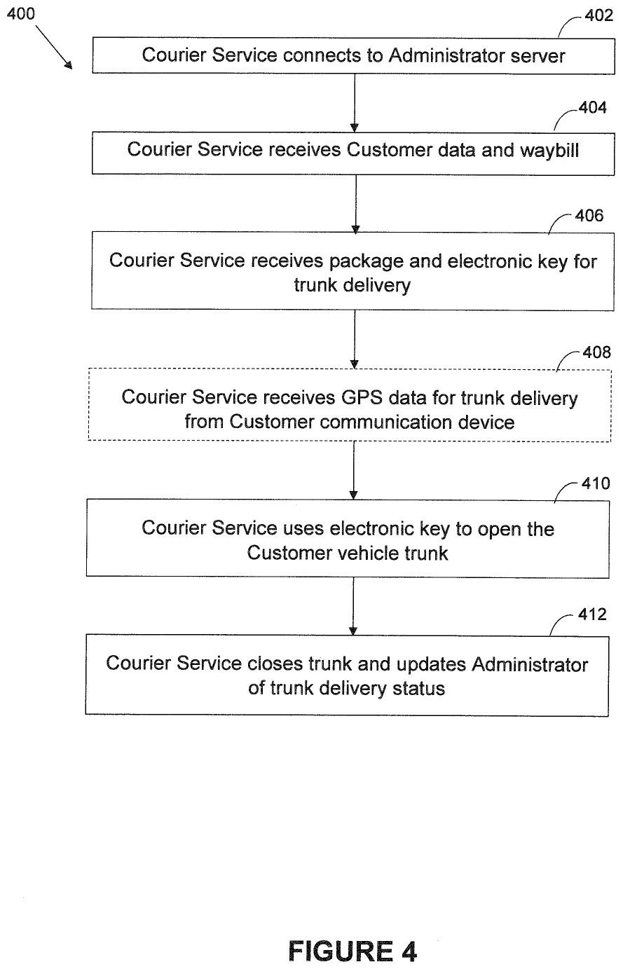

FIG. 4 is a flow diagram showing an exemplary method 400 involving a courier service 16. A courier service 16 is an entity that is engaged in the service of package delivery like the USPS, UPS delivery service, FEDEX delivery service, or any other similar entity. As a preliminary matter, an entity may be registered as a courier service 16 with the administrator 12. The courier service 16 will receive the API access for user and permission exchange. The administrator 12 server 14 will communicate with the server 18 of the courier service 16 over the network 40. The courier service 16 will store and execute an application on their server 18 that will work as a plug-in to the courier service's 16 existing software and the application will allow their server 18 to communicate with the server 14 of the administrator 12.

In FIG. 4, at step 402, the courier service's 16 server 18 will connect to the administrator's 12 server 14. The courier service 16 will receive the customer data and waybill from the sender (step 404) and the waybill will have been prepared by the sender. The sender may be a retailer 20 or may be any individual or other entity. The customer information and waybill would ideally include the customer's 30 name, location of customer's 30 vehicle 34 (e.g. parking lot address, cross streets, etc.), description of customer's 30 vehicle 34 (e.g. vehicle make, model, color, VIN number, license plate, etc.), sender's address, package description (e.g. size, weight, contents, etc.), package pick-up time and location, package delivery time, as well as any other information relevant to the vehicle trunk delivery. Upon receiving the location of the customer's 30 vehicle 34, the vehicle trunk delivery will be calculated into the courier service's 16 route structure/schedule. At step 406, the courier service 16 (via its driver employee) will pick up the package 42 from the sender and the courier service 16 will also receive from the administrator 12 the electronic key 46 associated with the communication device 36 installed in the customer's 30 vehicle 34. In one or more embodiments of the present invention, the courier service 16 may also receive the Global Position System (GPS) location of the customer's 30 vehicle 34 (step 408) (e.g. the courier service 16 may be equipped with a GPS device that may receive location information transmitted by the communication device 36 coupled to the OBD system 37 of the customer's 30 vehicle 34). At step 410, when the courier service 16 has located the customer's 30 vehicle 34, the communication device 36 connected to the OBD system 37 of the customer's 30 vehicle 34 will receive and execute the trunk-open command transmitted by the courier service's 16 electronic device 17 via BLUETOOTH wireless connection (the electronic key 46 allows the communication device 36 to receive the trunk-open command transmitted by the courier service's 16 electronic device 17. After placing the package 42 into the trunk 35 the courier service 16 will close the trunk 35, take a picture of the package 42 in the trunk 35 as proof of delivery and will inform the administrator 12 that the delivery has been completed so that the administrator 12 may update the status of the delivery (step 412) and may also inform the customer 30 that the package 42 has been delivered.

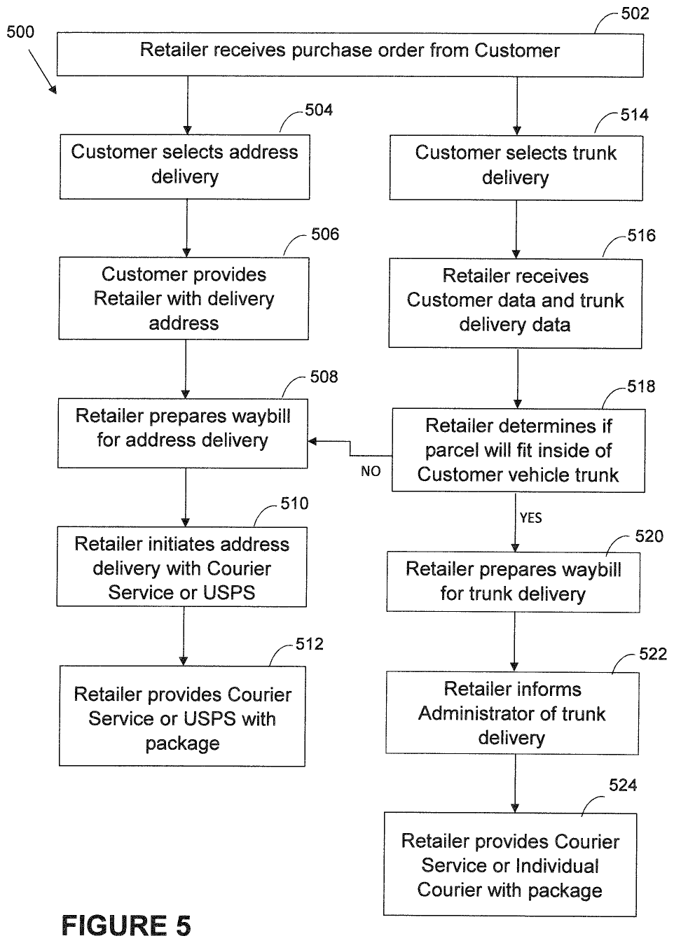

FIG. 5 is a flow diagram showing an exemplary method 500 involving a package sender that is a retailer 20. Although a retailer 20 is referred to in this example, it should be clearly understood that substantial benefit may be derived from the sender being an individual or some other type of entity that is capable of sending packages. As a preliminary matter, a store (e.g. e-commerce, brick-and-mortar, or a combination) may be registered as a retailer 20 with the administrator 12. The retailer 20 will receive the API access for user and permission exchange. The administrator's 12 server 14 will communicate with the server 22 of the retailer 20 over the network 40. The retailer 20 will store and execute an application on its server 22 that will work as a plug-in to the retailer's 20 existing software and the application will allow its server 22 to communicate with the server 14 of the administrator 12.

FIG. 5, at step 502, the retailer 20 will receive a purchase order from a customer 30. During the purchase process, the customer 30 will be able to select whether he/she wants the package 42 to be delivered to an address or to be delivered to the trunk 35 of the customer's 30 vehicle 34. If the customer 30 selects an address delivery (step 504), then the customer 30 will provide the retailer 20 with the delivery address (step 506). The retailer 20 will prepare the waybill for the delivery to the address indicated by the customer 30 (step 508). The retailer 20 will then initiate the delivery of the package 42 with a delivery service 16 or with the United States Postal Service (step 510). The retailer 20 will then provide the courier service 16 or the USPS with the package 42 (step 512) for delivery to the address.

Still referring to FIG. 5, at step 514, the customer 30 may select a vehicle trunk delivery. Upon the customer's 30 selection of a vehicle trunk delivery, the retailer 20 will receive customer data and trunk delivery data (step 516). In accordance with one or more embodiments of the present invention, the customer 30 may be asked to provide the retailer 20 with his/her account number that was issued by the administrator 12. When the retailer 20 provides the administrator 12 with the customer's 30 account number, the administrator 12 may then send the customer data and trunk delivery data the retailer 20. This data may include the customer's 30 name, location of customer's 30 vehicle 34 (e.g. parking lot address, cross streets, etc.), description of customer's 30 vehicle 34 (e.g. vehicle make, model, color, VIN number, license plate, vehicle trunk size, etc.) as well as any other information relevant to the vehicle trunk delivery. Alternatively, in accordance with one or more embodiments of the present invention, the customer data and trunk delivery data may be provided directly to the retailer 20 by the customer 30 at the time of purchase through the retailer's 20 website. Since the retailer 20 is familiar with the items purchased by the customer 30, the retailer 20 will be able to determine whether the package 42 containing the purchased items will be able to fit into the trunk 35 of the customer's 30 vehicle 34 (step 518). If the package 42 will not fit into the trunk 35 of the customer's 30 vehicle 34, then the retailer 20 will prepare the waybill for address delivery (to step 508). If the package 42 will fit into the trunk 35 of the customer's 30 vehicle 34, then the retailer 20 will prepare the waybill for vehicle trunk delivery (step 520). The retailer 20 will then inform the administrator 12 that a vehicle trunk delivery has been selected by a customer 30 (step 522) and will send the waybill and all other information relevant to the vehicle trunk delivery to the administrator 12. The administrator 12 will then coordinate delivery of the package 42 with either a courier service 16 or with an individual courier 24. The retailer 20 will then provide the package 42 to the courier service 16 or the individual courier 24 (step 524) for the vehicle trunk delivery.

Alternatively, in accordance with one or more embodiments of the present invention, retailers 20 offering curbside pickup or logistic hubs can utilize same-day delivery through the administrator 12 and dispatch nearest individual courier 24 that has the necessary trunk size to accommodate the package 42. Where the customer 30 is provided tracking information of the individual courier 24 and certain contact information is shared between customer 30 and individual courier 24.

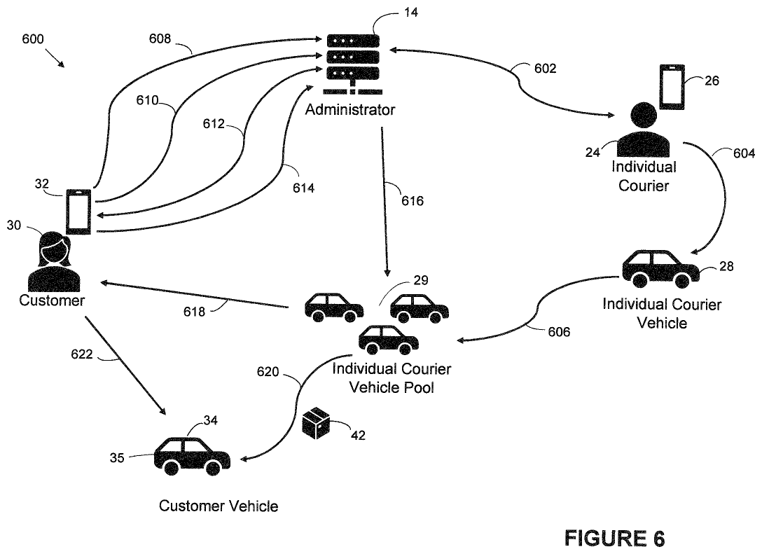

FIG. 6 is a diagram showing an exemplary method 600 of using the system 10 of the present invention involving an individual courier 24 and a customer 30. As a preliminary matter, a person or entity would register as a customer 30 with the administrator 12. During registration, the person or entity may provide the administrator 12 with certain customer data which may include the customer's 30 name, authentication credentials (e.g. identification and password), contact information (e.g. phone number, address, e-mail, etc.), Vehicle Identification Number (VIN), description of customer's 30 vehicle 34 (e.g. make, model, color, and trunk 35 size), as well as the customer's 30 credit card/debit card/bank account information if required. The customer 30 may download application software onto his/her electronic device 32 so that the electronic device 32 may communicate with the administrator's 12 server 14. The administrator 12 will also provide the customer 30 with a communication device 36 that the customer 30 will plug in/connect to the OBD 37 of the customer's 30 vehicle 34. The communication device 36 will have a unique serial number that will be associated with the customer 30 and with the VIN of the customer's 30 vehicle 34. The communication device 36 will also be associated with a unique electronic key 46 which will be used by the individual courier 24 to remotely open the trunk 35 of the customer's 30 vehicle 34 where the communication device 36 is located.

As another preliminary matter, a person may register as an individual courier 24 with the administrator 12 (step 602). During this process, the administrator 12 would receive the individual courier's 24 name, authentication credentials (e.g. identification and password), contact information (e.g. phone number, address, e-mail, etc.), insurance information as well as the individual courier's 24 driving record and any criminal record. The individual courier's 24 vehicle 28 will also have been registered with the administrator 12 (step 604) and in doing so the administrator 12 will receive the Vehicle Identification Number (VIN) and description of the individual courier's 24 vehicle 28 (e.g. make, model, color). The individual courier 24 and his/her vehicle 28 may then become a part of an individual courier vehicle pool 29 that is managed by the administrator 12 (step 606).

In FIG. 6, the communications among the involved parties may take place through the administrator's 12 server 14 or directly with each other. At step 608, the customer 30 will use his/her electronic device 32 to select unattended vehicle trunk delivery when selecting a shipping option through a retailer's 20 e-commerce website. The customer's 30 selection of a vehicle trunk delivery (i.e. trunk delivery request) may be sent to the administrator 12 server 14 (step 610). The retailer 20 may communicate with the administrator 12 regarding available times for pick-up of the package 42 and the administrator 12 may coordinate package 42 delivery times based upon the availability of divers within the individual courier vehicle pool 29. With this pick-up and delivery information, the details (e.g. time and place) of the trunk delivery request may be discussed between the customer 30 and the administrator 12 (step 612). If the delivery details are acceptable to the customer 30, the customer 30 may accept/confirm the vehicle trunk delivery (step 614).

At step 616, the administrator 12 may dispatch an individual courier 24 from the individual courier vehicle pool 29. At step 618, the individual courier 24 dispatched from the vehicle pool 29 will pick up the package 42 from the retailer 20 and the administrator 12 will send a notification to the customer 30 that the package 42 has been picked up from the retailer 20 and is ready for delivery. At this time, the customer 30 may also use his/her electronic device 32 to approve the delivery time or request an alternative delivery time. At the agreed upon delivery time, the individual courier 24 will drive to the location of the customer's 30 vehicle 34 (step 620). The individual courier 24 will place the package 42 in the trunk 35, take a photograph as proof of delivery, close the trunk 35, and will confirm delivery to the administrator 12 so that the administrator 12 may then notify the customer 30 and the retailer 20 of delivery of the package 42. At step 622 the customer 30 receives the package 42.

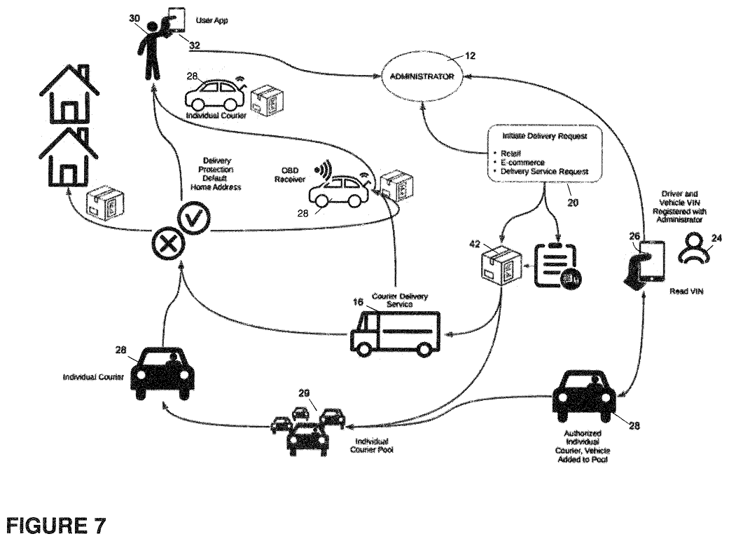

Referring to FIG. 7, another embodiment of the present invention is shown. In this embodiment, the on-demand same day trunk delivery service allows the administrator 12 to dispatch an individual courier 24 from the individual courier vehicle pool 29. The individual courier 24 will pick up the package 42 where the retailer 20 and the administrator 12 will send a notification to the customer 30 that the package 42 has been picked up from the retailer 20 and is ready for delivery. The retailer 20 takes a photograph as proof of placement, closes the trunk individual courier's 24 vehicle 28, and will confirm start of delivery to the administrator 12 so that the administrator 12 may then notify the customer 30 of delivery of the package 42. At this time, the customer 30 may also use his/her electronic device 32 to track the delivery progress and get notified on arrival. The individual courier 24 will drive to the location of the customer 30. The individual courier 24 will park his/her vehicle 28 and allow customer 30 to walk over to the individual courier's 24 vehicle 28 and open the trunk of the individual courier's 24 vehicle 28 using the customer's 30 electronic device 32 to open the trunk of the parked individual courier's 24 vehicle 28. The customer 30, using his/her electronic device 32 notifies administrator 12 that package 42 has been picked-up from the parked individual courier's 24 vehicle 28.

The foregoing description is illustrative of particular embodiments of the application, but it is not meant to be limitation upon the practice thereof. While embodiments of the disclosure have been described in terms of various specific embodiments, those skilled in the art will recognize that the embodiments of the disclosure may be practiced with modifications within the spirit and scope of the claims.

All references, including publications, patent applications, and patents, cited herein are hereby incorporated by reference in their entirety and to the same extent as if each reference were individually and specifically indicated to be incorporated by reference and were set forth in its entirety herein (to the maximum extent permitted by law), regardless of any separately provided incorporation of particular documents made elsewhere herein.

The use of the terms “a” and “an” and “the” and similar referents in the context of describing the invention are to be construed to cover both the singular and the plural, unless otherwise indicated herein or clearly contradicted by context.

Unless otherwise stated, all exact values provided herein are representative of corresponding approximate values (e.g., all exact exemplary values provided with respect to a particular factor or measurement can be considered to also provide a corresponding approximate measurement, modified by “about,” where appropriate). All provided ranges of values are intended to include the end points of the ranges, as well as values between the end points.

The description herein of any aspect or embodiment of the invention using terms such as “comprising”, “having,” “including,” or “containing” with reference to an element or elements is intended to provide support for a similar aspect or embodiment of the invention that “consists of”, “consists essentially of”, or “substantially comprises” that particular element or elements, unless otherwise stated or clearly contradicted by context (e.g., a composition described herein as comprising a particular element should be understood as also describing a composition consisting of that element, unless otherwise stated or clearly contradicted by context).

All headings and sub-headings are used herein for convenience only and should not be construed as limiting the invention in any way.

The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

The citation and incorporation of patent documents herein is done for convenience only and does not reflect any view of the validity, patentability, and/or enforceability of such patent documents.

This invention includes all modifications and equivalents of the subject matter recited in the claims and/or aspects appended hereto as permitted by applicable law.

What is claimed is:

1. A system for securely delivering a package to a trunk of a vehicle:
a network configured for communication between an administrator, a plurality of couriers, a plurality of package senders, and a plurality of package recipients; and
at least one administrator server with a database containing information for the plurality of package senders and the plurality of package recipients, wherein the at least one administrator server has a processor configured to access the database and to execute a set of program instructions causing the processor to:
generate an electronic key to be assigned to a specific vehicle associated with a courier or a package recipient;
receive a request for a trunk delivery from a package sender, the delivery request identifying the package recipient;
assign the trunk delivery to the courier;
identify the specific vehicle associated with the courier or the package recipient;
transmit the electronic key that is assigned to the specific vehicle to at least one of the package sender, the courier, and the package recipient;
update status of the trunk delivery; and
communicate with at least one of the package sender, the courier, and the package recipient relating to status of the trunk delivery.

2. The system of claim 1 further comprising:
a communication device configured to be coupled to an on-board device within the specific vehicle associated with the courier or the package recipient, wherein the communication device receives and executes trunk-open commands;
a workstation for generating the electronic key and assigning the electronic key to the communication device.

3. The system of claim 2 wherein the communication device is associated with the vehicle identification number (VIN) of the vehicle associated with the courier or the package recipient.

4. The system of claim 2 wherein the workstation is not connected to the network.

5. The system of claim 2 further comprising a courier electronic device for transmitting trunk-open commands to the communication device coupled to the on-board device of the specific vehicle associated with the package recipient.

6. The system of claim 5 wherein the courier electronic device:
receives the electronic key from the administrator or the package recipient; and
transmits the electronic key to the communication device coupled to the on-board device of the specific vehicle associated with the package recipient.

7. The system of claim 6 wherein the communication device coupled to the on-board device of the specific vehicle associated with the package recipient will not execute the trunk-open command unless the electronic key is sent from the courier electronic device and received by the communication device coupled to the on-board device of the specific vehicle associated with the package recipient.

8. The system of claim 7 wherein the electronic key is sent and received between the courier electronic device and the communication device coupled to the on-board device of the specific vehicle associated with the package recipient via short range BLUETOOTH wireless connection.

9. The system of claim 2 further comprising a package recipient electronic device for transmitting trunk-open commands to the communication device coupled to the on-board device of the specific vehicle associated with the courier.

10. The system of claim 9 wherein the package recipient electronic device:
receives the electronic key from the administrator or the courier; and
transmits the electronic key to the communication device coupled to the on-board device of the specific vehicle associated with the courier.

11. The system of claim 10 wherein the communication device coupled to the on-board device of the specific vehicle associated with the courier will not execute the trunk-open command unless the electronic key is sent from the package recipient electronic device and received by the communication device coupled to the on-board device of the specific vehicle associated with the courier.

12. The system of claim 11 wherein the electronic key is sent and received between the package recipient electronic device and the communication device coupled to the on-board device of the specific vehicle associated with the courier via short range BLUETOOTH wireless connection.

13. The system of claim 2 further comprising a package recipient electronic device for transmitting trunk-open commands to the communication device coupled to the on-board device of the vehicle associated with the package recipient.

14. A method for securely delivering a package to a trunk of a vehicle comprising the steps of:
generating an electronic key to be assigned to a specific vehicle associated with a courier or a package recipient;
receiving a request for a trunk delivery from a package sender, the delivery request identifying the package recipient;
assigning the trunk delivery to the courier;
identifying the specific vehicle associated with the courier or the package recipient;
transmitting the electronic key that is assigned to the specific vehicle to at least one of package sender, the courier, and the package recipient;
updating status of the trunk delivery; and
communicating with at least one of the package sender, the courier, and the package recipient relating to the status of the trunk delivery.

15. The method of claim 14 further comprising the step of generating the electronic key from an offline workstation.

16. The method of claim 14 further comprising the steps of:
assigning the electronic key to a communication device;
associating the communication device with a vehicle identification number (VIN) of the specific vehicle associated with the courier or the package recipient;
coupling the communication device to an on-board device within the specific vehicle associated with the courier or the package recipient, wherein the communication device receives and executes trunk-open commands;
wherein the communication device coupled to the on-board device of the specific vehicle associated with the courier or the package recipient will not execute the trunk-open command unless the electronic key is received by the communication device coupled to the on-board device of the specific vehicle associated with the courier or the package recipient.

17. The method of claim 16 wherein the electronic key is sent from a package recipient electronic device and received by the communication device coupled to the on-board device of the specific vehicle associated with the courier via short range BLUETOOTH wireless connection.

18. The method of claim 16 wherein the electronic key is sent from a courier electronic device and received by the communication device coupled to the on-board device of the specific vehicle associated with the package recipient via short range BLUETOOTH wireless connection.

39. A method for securely delivering a package to a trunk of a vehicle comprising the steps of:
generating an electronic key to be assigned to a communication device;
associating the communication device with a vehicle identification number (VIN) of a specific vehicle associated with a courier or a package recipient;
issuing the communication device to the courier or the package recipient so that it may be coupled to an on-board device of the specific vehicle associated with the courier or the package recipient;
receiving a request for a trunk delivery from a package sender, the delivery request identifying the package recipient;
identifying the specific vehicle associated with the courier or the package recipient;
identifying the electronic key assigned to the communication device that is associated with the VIN of the specific vehicle associated with the courier or the package recipient; and
transmitting the electronic key assigned to the communication device that is associated with the VIN of the specific vehicle associated with the courier or the package recipient to at least one of the package sender, the courier, and the package recipient;
wherein the communication device, when coupled to the on-board device of the specific vehicle associated with the courier or the package recipient, will only execute a trunk-open command if the electronic key is transmitted from a courier electronic device or from a package recipient electronic device and is received by the communication device coupled to the on-board device of the specific vehicle associated with the courier or the package recipient.

20. The method of claim 19 wherein the trunk-open command is transmitted from a package recipient electronic device or from a courier electronic device via short-range BLUETOOTH wireless connection to the communication device coupled to the on-board device of the specific vehicle associated with the courier or the package recipient.
